(19) United States
(12) Patent Application Publication
(10) Pub. No.: US 2003/0207979 A1
(43) Pub. Date: Nov. 6, 2003

(54) Wear resistant, flame-retardant composition and electric cable covered with said composition

(75) Inventors: Masashi Sato, Yokkaichi-city (JP); Shinichi Matsumoto, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 10/319,488

(22) Filed: Dec. 16, 2002

(30) Foreign Application Priority Data
Dec. 17, 2001 (JP) 2001-382711

(51) Int. Cl. C08K 3/10

(52) U.S. Cl. 524/436; 524/437

(57) ABSTRACT

The present invention relates to a resin composition comprising: (a) 30 to 90 parts by mass of polyethylene having a melt flow rate (MFR) of about 5 g/10 min at the most and a density of at least 0.930; (b1) 5 to 65 parts by mass of olefin type polymer containing intra molecular oxygen atoms; (c) 5 to 40 parts by mass of at least one type of polymer selected from the group consisting of (c1) acid modified olefin polymers containing intra-molecular oxygen atoms, (c2) acid modified styrene type thermoplastic elastomers, (c3) acid-modified polyethylenes having a density of about 0.920 at the most, and (c4) acid modified rubbers, with the proviso that the total of components (a), (b1) and (c) represents 100 parts by mass; and (d) 30 to 250 parts by mass of metal hydroxide. This abstract is neither intended to define the invention disclosed in this specification nor intended to limit the scope of the invention in any way.

### BACKGROUND OF THE INVENTION

1. Field of the Invention

The present invention relates to a wear resistant, flame-retardant material composition and to an electric cable or wire covered with a material containing such a composition. This type of protected electric cable or wire is used, for example, in automotive vehicles.

2. Description of Background Information

Polyvinyl chloride has been widely used as a coating material for electrical cables or wires used in vehicles, owing to its excellent mechanical strength, facility with which it can be extruded around an electric cable, its excellent flexibility and paintability, as well as its low cost.

However, because of recent environmental measures, manufacturing of parts for vehicles, including coatings of electrical wires used in vehicles, has started to use halogen free (polymer) materials instead of polyvinyl chloride.

A halogen free resin composition containing a polyolefin as a base polymer and metal hydroxides as flame retardants is well known (see JP-A-7-176219 and JP-A-7-78518). This composition is a wear resistant resin composition and has the advantage of not producing toxic gas such as halogen gas when burning.

However, it is necessary to add large amounts of metal hydroxides to make this composition sufficiently flame retardant to yield a self extinguishing property. When adding such large amounts of metal hydroxides, the mechanical strength of the composition, such as its wear resistance and tensile strength falls dramatically. To prevent such lowering of mechanical strength, it has been suggested to raise the amount of propylene having a relatively high hardness and the amount of polypropylene having a high density. However, in this case, the flexibility of the protected electric cable or wire is then lowered and the manufacturability thereof is also lowered.

JP-A-6-290638 discloses a resin composition containing metal hydroxides used for insulating electrical wires. This composition contains polypropylene as the main component (more than 80%). The other components of this composition are copolymers of styrene and polyethylene modified by acid anhydrides.

U.S. Pat. No. 5,561,185 discloses as a resin composition containing metal hydroxides, used for protecting electrical wires, a resin composition containing:

(a) 40 to 88.5% by mass (or by weight) of a polypropylene type resin containing at least 50% by mass of ethylene-propylene random copolymers;

(b) 1.5 to 30% by mass of polyethylene modified by an unsaturated carboxylic acid or derivatives thereof (e.g. maleic anhydride); and

(c) 10 to 48% by mass of ethylene type copolymer, typically ethylene/vinyl acetate copolymer.

U.S. Pat. No. 5,180,889 discloses a resin composition containing metal hydroxides as a coating for the conductor of a crush resistant cable. This composition contains:

a) ethylene/α olefin copolymer having a low density;

b) a system of styrene-ethylene-butylenes-styrene tri-block copolymer-elastomer, preferably modified by maleic anhydride; and

c) optionally, a shock-resistant propylene copolymer or polypropylene.

It has been proposed to improve the heat resistance of the resin composition used for electrical wire insulation by cross-linking the resin composition.

JP-A-8-161942 proposes to coat electrical wires with a resin composition containing an ethylene-vinyl acetate copolymer (EVA), ethylene-ethyl acrylate (EEA) and metal hydrates, and to cross-link this composition using electron beam irradiation.

JP-A-2000-294039 proposes to cross-link a composition containing ethylene type polymer(s) and maleic anhydride modified polyolefins.

The compositions obtained by cross-linking a resin composition containing as a base an ethylene type polymer have excellent heat resistance but insufficient wear resistance.

JP-A-2000-86830 discloses a composition obtained by cross-linking a resin composition containing polyolefin type elastomers, metal hydroxides and a coupling-agent surface treated potassium titanate.

JP-A-2000-336215 discloses a resin composition containing a polyolefin type resin prepared with magnesium hydroxide or aluminum hydroxide whose surface is treated, silicone powder and a cross-linking accelerator. This composition is also cross-linked.

Such compositions have an improved tensile and mechanical strength, but a poor flexibility and formability.

### SUMMARY OF THE INVENTION

One purpose of the present invention is to provide a flame retardant resin composition containing metal hydroxides which is suitable for coating electrical wires or cables, and which has an improved flame retardant quality, as well as improved wear resistance, flexibility and formability.

To solve the above-mentioned problem, there is provided a resin composition comprising:

(a) about 30 to 90 parts by mass of polyethylene having a melt flow rate (MFR) of about 5 g/10 min at the most and a density of at least about 0.930;

(b1) about 5 to 65 parts by mass of olefin type polymer containing intra molecular oxygen atoms;

(c) about 5 to 40 parts by mass of at least one type of polymer selected from the group consisting of:

(c1) acid modified olefin polymers containing intra-molecular oxygen atoms;

(c2) acid modified styrene type thermoplastic elastomers;

(c3) acid-modified polyethylenes having a density of about 0.920 at the most; and

(c4) acid modified rubbers,

with the proviso that the total of components (a), (b1) and (c) represents 100 parts by mass; and

(d) about 30 to 250 parts by mass of metal hydroxide.

Preferably, the resin composition is cross-linked by electron beam irradiation.

Alternatively, the invention relates to a resin composition comprising:

(a) about 30 to 90 parts by mass of polyethylene having a melt flow rate (MFR) of about 5 g/10 min at the most and a density of at least about 0.930;

(b2) about 5 to 65 parts by mass of styrene type thermoplastic elastomer; and

(c) about 5 to 40 parts by mass of at least one type of polymer selected from the group consisting of:

(c1) acid modified olefin type polymers containing intra-molecular oxygen atoms, and

(c2) acid modified styrene type thermoplastic elastomers;

with the proviso that the total of components (a), (b2) and (c) represents 100 parts by mass; and

(d) about 30 to 250 parts by mass of metal hydroxide.

Preferably, the resin composition is cross-linked by electron beam irradiation.

The invention further relates to a process for applying, to a conductor element, a resin composition comprising:

(a) about 30 to 90 parts by mass of polyethylene having a melt flow rate (MFR) of about 5 g/10 min at the most and a density of at least about 0.930;

(b1) about 5 to 65 parts by mass of olefin type polymer containing intra molecular oxygen atoms;

(c) about 5 to 40 parts by mass of at least one type of polymer selected from the group consisting of:

(c1) acid modified olefin polymers containing intra-molecular oxygen atoms;

(c2) acid modified styrene type thermoplastic elastomers;

(c3) acid-modified polyethylenes having a density of about 0.920 at the most; and

(c4) acid modified rubbers,

with the proviso that the total of components (a), (b1) and (c) represents 100 parts by mass; and

(d) about 30 to 250 parts by mass of metal hydroxide;

so as to prepare an electrical cable.

Preferably, the above process further comprises the step of irradiating the resin composition with electron beams.

Alternatively, the invention concerns a process for applying, to a conductor element, a resin composition comprising:

(a) about 30 to 90 parts by mass of polyethylene having a melt flow rate (MFR) of about 5 g/10 min at the most and a density of at least about 0.930;

(b2) about 5 to 65 parts by mass of styrene type thermoplastic elastomer; and

(c) about 5 to 40 parts by mass of at least one type of polymer selected from the group consisting of:

(c1) acid modified olefin type polymers containing intra-molecular oxygen atoms, and

(c2) acid modified styrene type thermoplastic elastomers;

with the proviso that the total of components (a), (b2) and (c) represents 100 parts by mass; and

(d) about 30 to 250 parts by mass of metal hydroxide;

so as to prepare an electrical cable.

Preferably, the above process further comprises the step of irradiating the resin composition with electron beams.

There is further provided an electrical cable coated with a resin composition comprising:

(a) about 30 to 90 parts by mass of polyethylene having a melt flow rate (MFR) of about 5 g/10 min at the most and a density of at least about 0.930;

(b1) about 5 to 65 parts by mass of olefin type polymer containing intra molecular oxygen atoms;

(c) about 5 to 40 parts by mass of at least one type of polymer selected from the group consisting of:

(c1) acid modified olefin polymers containing intra-molecular oxygen atoms;

(c2) acid modified styrene type thermoplastic elastomers;

(c3) acid-modified polyethylenes having a density of about 0.920 at the most; and

(c4) acid modified rubbers,

with the proviso that the total of components (a), (b1) and (c) represents 100 parts by mass; and

(d) about 30 to 250 parts by mass of metal hydroxide.

Suitably, the resin composition is further cross-linked by electron beam irradiation.

There is further provided an electrical cable coated with a resin composition comprising:

(a) about 30 to 90 parts by mass of polyethylene having a melt flow rate (MFR) of about 5 g/10 min at the most and a density of at least about 0.930;

(b2) about 5 to 65 parts by mass of styrene type thermoplastic elastomer; and

(c) about 5 to 40 parts by mass of at least one type of polymer selected from the group consisting of:

(c1) acid modified olefin type polymers containing intra-molecular oxygen atoms and

(c2) acid modified styrene type thermoplastic elastomers;

with the proviso that the total of components (a), (b2) and (c) represents 100 parts by mass; and

(d) about 30 to 250 parts by mass of metal hydroxide.

Suitably, the resin composition is further cross-linked by electron beam irradiation.

### DETAILED DESCRIPTION OF THE PREFERRED EMBODIMENTS

Each component of the composition of the invention is chosen in order to confer, when mixed with the others, a desired property to the resulting material. Explanations regarding each of the components are given hereinafter.

Component (a) is a polyethylene having a melt flow rate (MFR) of 5 g/10 min or less and a density of at least 0.930.

The polyethylene used can be any polyethylene having the above-mentioned density and melt flow rate. However, high density polyethylene or straight-chain low density polyethylene are preferably used.

When the MFR of polyethylene exceeds 5 g/10 min, the formability of the composition is deteriorated.

The MFR value is measured according to JIS K 6921-2.

Moreover, when the density of the polyethylene is less than 0.930, the hardness of the composition is lowered, and its wear resistance is also lowered.

The amount of component (a) represents 30 to 90 parts by mass, preferably 30 to 80 parts by mass, in the total of 100 parts by mass consisting of component (a), component (b1) or (b2) and component (c).

When the amount of component (a) is higher than the upper limit, the flexibility and formability of the composition are lowered. When this amount is lower than the lower limit, the composition has a poor wear resistance.

Examples of olefin polymers (b1) containing intramolecular oxygen atoms include a copolymer of olefins (e.g. ethylene) and unsaturated monomers containing oxygen atoms (e.g. vinyl acetate, ethyl acrylate and ethyl methacrylate). In practice, ethylene-vinyl acetate copolymers, ethylene-ethyl acrylate copolymers and ethylene-methyl methacrylate copolymers can be given as examples.

The styrene type thermoplastic elastomers (b2) may be, for example, thermoplastic copolymers of styrene and olefins (e.g. ethylene or propylene). Practically, styrene-ethylene block copolymers, styrene-ethylene-propylene block copolymers and their hydrogenated derivatives obtained by adding hydrogen atoms in their unsaturated bonds can be given as examples.

The amount of component (b1) or (b2) ranges from 5 to 65 parts by mass, preferably from 10 to 60 parts by mass, in the total of 100 parts by mass consisting of component (a), component (b1) or (b2) and component (c).

When the amount of component (b1) or (b2) is higher than the above-mentioned upper limit, the wear resistance of the composition is lowered. When this amount is lower than the above-mentioned lower limit, the flexibility and formability of the composition are lowered.

Examples of acid-modified olefin polymers (c1) containing intramolecular oxygen atoms include polymers which may be obtained by introducing, as acid components, unsaturated carboxylic acids or their derivatives (e.g. anhydrides or esters) into olefin polymers (b1) containing intramolecular oxygen atoms. Typical examples of such unsaturated carboxylic acids or their derivatives include maleic acid, fumaric acid, maleic anhydride, maleic acid monoesters and maleic acid diesters.

The acids can be introduced into the olefin type polymer by grafting or by any direct method (copolymerization). The amount of acid used for modification or denaturation preferably range from 0.1 to 20 by mass with respect to the mass amount of olefin type polymer.

The acid-modified styrene type thermoplastic elastomers (c2) may be the polymers obtained by introducing, as acid components, unsaturated carboxylic acids or their derivatives (e.g. acid anhydrides or esters) into styrene type thermoplastic elastomers (b2). The types of unsaturated carboxylic acids or their derivatives, the method of their introduction and the amount used are the same as described above for the case of component (c1).

The acid-modified polyethylene (c3) having a density of 0.920 or less may be the polymers obtained by introducing, as acid components, unsaturated carboxylic acids or their derivatives (e.g. acid anhydrides or esters) into relatively low density polyethylene (e.g. so-called ultra-low density polyethylene such as ethylene-octene copolymers). The types of unsaturated carboxylic acids or their derivatives, the method of their introduction and the amount used are the same as described above for the case of component (c1).

When the density of acid modified polyethylene is more than 0.920, the hardness of the composition is increased and its flexibility is lowered.

The acid modified rubber (c4) may be obtained, for example, by introducing the above-mentioned unsaturated carboxylic acids or their derivatives into a rubber. Examples of such rubber include ethylene-propylene rubber, ethylene-propylene-diene rubber or the like. The types of unsaturated carboxylic acids or their derivatives, the method of their introduction and the amount used are the same as described above for the case of component (c1).

The amount of component (c) represents from 5 to 40 parts by mass, preferably 10 to 40 parts by mass, in the total of 100 parts by mass consisting of component (a), component (b1) or (b2) and component (c).

When the amount of component (c) is greater than the above-mentioned upper limit, the wear resistance of the composition is lowered. Conversely, when its amount is less than the above-mentioned lower limit, the flexibility and formability of the composition tends to decrease.

Examples of metal hydroxides (d) include magnesium hydroxide, aluminum hydroxide, and the like. Metal hydroxide particles need not be specifically treated. However, the surface may also be treated with a surface treatment agent such as coupling agents, in particular, silane coupling agents (e.g. amino silane coupling agent, vinyl silane coupling agent, epoxy silane coupling agent, methacryloxysilane coupling agent) or optionally higher fatty acids (e.g. stearic acid, oleic acid or the like).

A silane coupling agent typically contains a Si—O bond which can form a bond with hydroxides. Among metal hydroxides, a preferred compound is magnesium hydroxide or aluminium hydroxide whose surface is treated with a coupling agent, preferably a silane coupling agent, in particular an aminosilane coupling agent.

The particles of metal hydroxides need not be pre-treated with a coupling agent. Instead, they may be mixed directly with a resin, then supplemented with a coupling agent, according to a method called “integral blending”.

The amount of metal hydroxide usually represents from 30 to 250 parts by mass, preferably from 50 to 200 parts by mass, of the total of component (a), component (b1) or (b2) and component (c) representing 100 parts by mass.

Any known additive may be added into the composition in such an amount that does not damage preferable characteristics of the composition. Examples of the above additives include those usually added into olefin type resins such as heat stabilizers (e.g. oxidation-preventing agents), metal-inactivating agents (copper-pollution preventing agents), lubricants (fatty acids, fatty acid amides, metallic soaps, hydrocarbons e.g. wax, esters, silicone type lubricants), light stabilizers, core-forming agents, electrification-preventing agents, colorants, flame retardant adjuvants, (e.g. zinc borate, silicone type flame retardant, nitrogen type retardant), coupling agents (e.g. silane type coupler, titanate type coupler), softening agents (e.g. process oils), cross-linking adjuvants (poly functional monomers and the like).

The resin composition of the invention may be prepared by mixing and/or kneading the components cited above according to any known method.

The resin composition of the invention may be cross-linked according to any known method e.g. electron beam irradiation.

The resin composition of the present invention may be used for coating electrical cables, in particular electrical cables for vehicles according to any known method.

The above, and the other features and advantages of the present invention will be made apparent from the following description of the preferred examples, given as non-limiting examples, with references to the following Examples and Comparative Examples.

### EXAMPLES 1 TO 10 AND COMPARATIVE EXAMPLES 1 TO 9

The components shown in Tables 1 to 4 were mixed together in the amounts (parts by mass) indicated therein, kneaded in a temperature range of 180° C. to 260° C., and extruded into pellets by a two-axis extruder. The pellets were dried and extruded and shaped around a conductor element (7/0.30) having a cross section of 0.5 mm², so as to yield a coating of 0.28 mm thick. The coated resin composition was then cross-linked by electron beam irradiation.

The extrusion-shaping was performed using a nipple and die respectively having a diameter of about 0.93 mm and about 1.45 mm. The extrusion temperatures for the die and cylinder were respectively about 180° C. to about 250° C. and about 160° C. to about 240° C. The extrusion line speed was 100 m/min.

The electron beam irradiation conditions were as follows.

Device: EPS-750 KV

Irradiation intensity: 120 KGy

The following properties of the coated electrical cables obtained in Examples 1 to 10 and Comparative Examples 1 to 9 were evaluated.

Flexibility:

The flexibility was evaluated on the basis of resistance feeling, when the electrical cable was bent manually.

Wear Resistance and Flame Retardant Quality

Wear resistance and flame retardant quality were measured according to Standards JASO D 611. As to wear resistance, the results were considered good when the minimum value among 3 samples tested was more than 150 times.

Formability

The formability was evaluated by observing whether or not whiskers were formed when coatings were peeled at the end portion of electrical cables. The results are shown in Tables 1 to 4

TABLE 1

| | Example | Example | Example | Example | Example |
|---|---|---|---|---|---|
| | 1 | 2 | 3 | 4 | 5 |
| HDPE ¹⁾ | 65 | 50 | 65 | 30 | 40 |
| LLDPE ²⁾ | | | | | |
| EVA ³⁾ | 30 | 10 | | 65 | 30 |
| EEA ⁴⁾ | | | 5 | | |
| MAH- | 5 | 40 | 30 | | 30 |
| EVA ⁵⁾ | | | | | |
| MAH- | | | | 5 | |
| EEA ⁶⁾ | | | | | |
| magnesium | 100 | 120 | 100 | 250 | 30 |
| hy- | | | | | |
| droxide ⁷⁾ | | | | | |
| anti-aging | 1 | 1 | 1 | 1 | 1 |
| agent ⁸⁾ | | | | | |
| cross- | 4 | 4 | 2 | 4 | |
| linking | | | | | |
| ad- | | | | | |
| juvant ⁹⁾ | | | | | |
| Total | 205 | 225 | 203 | 355 | 131 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 2

| | Example | Example | Example | Example | Example |
|---|---|---|---|---|---|
| | 6 | 7 | 8 | 9 | 10 |
| HDPE ¹⁾ | | 50 | 50 | 70 | 40 |
| LLDPE ²⁾ | 90 | | | | |
| EVA ³⁾ | 5 | 30 | | 10 | 40 |
| EEA ⁴⁾ | | | 30 | | |
| MAH- | 5 | 20 | 20 | | 20 |
| EVA ⁵⁾ | | | | | |
| MAH- | | | | 20 | |
| EEA ⁶⁾ | | | | | |
| magnesium | 40 | 90 | 100 | 120 | 30 |
| hy- | | | | | |
| droxide ⁷⁾ | | | | | |
| anti-aging | 1 | 1 | 1 | 1 | 1 |
| agent ⁸⁾ | | | | | |
| cross- | 2 | 4 | 4 | 2 | 2 |
| linking | | | | | |
| agent ⁹⁾ | | | | | |
| Total | 143 | 195 | 205 | 223 | 133 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 3

| | Comparative | Comparative | Comparative | Comparative | Comparative |
|---|---|---|---|---|---|
| | Example 1 | Example 2 | Example 3 | Example 4 | Example 5 |
| HDPE ¹⁾ | 100 | | 20 | | |
| LLDPE ²⁾ | | | | 30 | |
| EVA ³⁾ | | 100 | | 70 | 50 |
| PP ¹⁰⁾ | | | | | |
| MAH-EVA ⁵⁾ | | | 80 | | 50 |
| MAH-PP ¹¹⁾ | | | | | |
| magnesium | 100 | 80 | 50 | 100 | 30 |
| hydroxide ⁷⁾ | | | | | |
| anti-aging agent ⁸⁾ | 1 | 1 | 1 | 1 | 1 |
| cross-linking | 4 | 2 | 2 | 2 | 2 |
| agent ⁹⁾ | | | | | |
| Total | 205 | 183 | 153 | 203 | 133 |
| Flexibility | failed | passed | passed | passed | passed |
| wear resistance | passed | failed | failed | failed | failed |
| flame retardant | passed | passed | passed | passed | passed |
| quality | | | | | |
| Formability | failed | passed | passed | passed | passed |

TABLE 4

| | Compar- | Compar- | Compar- | Compar- |
|---|---|---|---|---|
| | ative | ative | ative | ative |
| | Example 6 | Example 7 | Example 8 | Example 9 |
| HDPE¹⁾ | 65 | 60 | 85 | 70 |
| LLDPE²⁾ | | | | |
| EVA³⁾ | | 10 | 10 | 25 |
| PP¹⁰⁾ | 30 | | | |
| MAH-EVA⁵⁾ | 5 | | 5 | 5 |
| MAH-PP¹¹⁾ | | 30 | | |
| magnesium | 30 | 200 | 10 | 300 |
| hydroxide⁷⁾ | | | | |
| anti-aging | 1 | 1 | 1 | 1 |
| agent⁸⁾ | | | | |
| cross-linking | 2 | 4 | 2 | 2 |
| agent⁹⁾ | | | | |
| Total | 133 | 305 | 112 | 403 |
| flexibility | failed | failed | passed | failed |
| wear resistance | passed | passed | passed | passed |
| flame retardant | passed | passed | failed | passed |
| quality | | | | |
| formability | failed | failed | passed | failed |

¹⁾high density polyethylene “HY331” manufactured by Japan Polychem Co., Ltd.. (MFR: 1.0 g/10 min (JIS K 6760); density: 0.950).
²⁾straight-chain low density polyethylene “DFDJ 7540” manufactured by Japan Unika Co., LTd.. (MFR: 0.7 g/10 min (JIS K 6760); density: 0.92).
³⁾ethylene-vinyl acetate copolymer “EV 360” manufactured by Mitsui Dupont Co., Ltd..
⁴⁾ethylene-ethyl acrylate copolymer “A 714” manufactured by Mitsui Dupont Co., Ltd..
⁵⁾maleic anhydride modified ethylene-vinyl acetate copolymer “VR-103” manufactured by Mitsui Dupont Co., Ltd..
⁶⁾maleic anhydride modified ethylene-ethyl acrylate copolymer “AR-201” manufactured by Mitsui Dupont Co., Ltd..
⁷⁾KISUMA 5 manufactured by Kyowa Chemicals Co., Ltd..
⁸⁾Hindered phenol type anti oxidant “Tominox TT” manufactured by Yoshitomi Pharmaceuticals Co. Ltd.
⁹⁾TMPT manufactured by New Nakamura Chemicals Co. Ltd;
¹⁰⁾polypropylene “RB610A” manufactured by Tokuyama Co., Ltd..
¹¹⁾maleic anhydride modified polypropylene “ER 320P” manufactured by Japan Polyolefin Co., Ltd..

From the results of Comparative Examples 1 to 5, it can be understood that, when the amount of any one component chosen among components (a), (b1) and (c1) is outside the range defined in the present invention, at least one of the tested physical properties is not satisfied.

The results of Comparative Examples 6 and 7 show that, when any one of component (b1) and component (c1) is not used, the flexibility and formability of the composition deteriorate.

The results of Comparative Examples 8 and 9 indicate that, when the amount of magnesium hydroxide, a flame retardant (d) is too small, the flame retardant quality of the composition deteriorates. Conversely, when this amount is too large, the flexibility and formability of the composition deteriorate.

### EXAMPLES 11 TO 20 AND COMPARATIVE EXAMPLES 10 TO 18

The components shown in Tables 5 to 8 were used in the amounts indicated therein (parts by mass). Coated electrical cables were produced through the methods described for Examples 1 to 10, and the properties of the obtained coating were evaluated. The results thus obtained are given in Tables 5 to 8.

TABLE 5

| | Example | Example | Example | Example | Example |
|---|---|---|---|---|---|
| | 11 | 12 | 13 | 14 | 15 |
| HDPE ¹⁾ | 60 | 50 | 65 | 30 | 50 |
| LLDPE ²⁾ | | | | | |
| EVA ³⁾ | 35 | 10 | | 65 | 30 |
| EEA ⁴⁾ | | | 5 | | |
| MAH- | 5 | 40 | 30 | 5 | 20 |
| SEBS ¹²⁾ | | | | | |
| MAH-PP ¹¹⁾ | | | | | |
| magnesium | 120 | 100 | 100 | 250 | 30 |
| hydroxide ⁷⁾ | | | | | |
| anti-aging | 1 | 1 | 1 | 1 | 1 |
| agent ⁸⁾ | | | | | |
| cross-linking | 4 | 4 | 2 | 4 | 2 |
| agent ⁹⁾ | | | | | |
| Total | 225 | 205 | 203 | 355 | 133 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 6

| | Example | Example | Example | Example | Example |
|---|---|---|---|---|---|
| | 16 | 17 | 18 | 19 | 20 |
| HDPE ¹⁾ | | 50 | 50 | 70 | 60 |
| LLDPE ²⁾ | 90 | | | | |
| EVA ³⁾ | 5 | 30 | | 10 | 20 |
| EEA ⁴⁾ | | | 30 | | |
| MAH- | 5 | 20 | 20 | 20 | 20 |
| SEBS ¹²⁾ | | | | | |
| MAH-PP ¹¹⁾ | | | | | |
| magnesium | 50 | 90 | 100 | 120 | 30 |
| hydroxide ⁷⁾ | | | | | |
| anti-aging | 1 | 1 | 1 | 1 | 1 |
| agent ⁸⁾ | | | | | |
| cross-linking | 4 | 4 | 4 | 4 | 4 |
| agent ⁹⁾ | | | | | |
| total | 155 | 195 | 205 | 225 | 135 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 7

| | Comparative | Comparative | Comparative | Comparative | Comparative |
|---|---|---|---|---|---|
| | Example 10 | Example 11 | Example 12 | Example 13 | Example 14 |
| HDPE ¹⁾ | 100 | | 20 | | |
| LLDPE ²⁾ | | | | 20 | |
| EVA ³⁾ | | 100 | | 80 | 50 |
| PP ¹⁰⁾ | | | | | |
| MAH-SEBS ¹²⁾ | | | 80 | | 50 |
| MAH-PP ¹¹⁾ | | | | | |
| magnesium | 90 | 100 | 80 | 100 | 30 |
| hydroxide ⁷⁾ | | | | | |
| anti-aging agent ⁸⁾ | 1 | 1 | 1 | 1 | 1 |
| cross-linking agent ⁹⁾ | 4 | 2 | 4 | 4 | 4 |
| Total | 195 | 203 | 185 | 205 | 135 |
| flexibility | failed | passed | passed | passed | passed |
| wear resistance | passed | failed | failed | failed | failed |
| flame retardant quality | passed | passed | passed | passed | passed |
| formability | passed | passed | passed | passed | passed |

TABLE 8

| | Compar- | Compar- | Compar- | Compar- |
|---|---|---|---|---|
| | ative | ative | ative | ative |
| | Example 15 | Example 16 | Example 17 | Example 18 |
| HDPE¹⁾ | 55 | 60 | 75 | 80 |
| LLDPE²⁾ | | | | |
| EVA³⁾ | | 10 | 5 | 10 |
| PP¹⁰⁾ | 40 | | | |
| MAH-SEBS¹²⁾ | 5 | | 20 | 20 |
| MAH-PP¹¹⁾ | | 30 | | |
| magnesium | 30 | 180 | 10 | 300 |
| hydroxide⁷⁾ | | | | |
| anti-aging | 1 | 1 | 1 | 1 |
| agent⁸⁾ | | | | |
| cross-linking | 2 | 2 | 4 | 4 |
| agent⁹⁾ | | | | |
| total | 133 | 283 | 115 | 405 |
| flexibility | failed | failed | passed | failed |
| wear resistance | passed | passed | passed | passed |
| flame retardant | passed | passed | failed | passed |
| quality | | | | |
| formability | failed | failed | passed | failed |

Remarks in Tables 5 to 8:
Footnotes ¹⁾ to ⁴⁾ and ⁷⁾ to¹¹⁾: see the footnotes for Tables 1 to 4.
¹²⁾maleic anhydride modified, hydrogenated styrene-butadiene block copolymer “Tuftec ™ M1913” manufactured by Asahi Chemicals Co., Ltd..

From the results of Comparative Examples 10 to 14, it can be understood that, when the amount of any one component chosen among component (a), (b1) and (c2) is outside the range defined in the present invention, at least one of the physical properties tested is not satisfied.

The results of Comparative Example 15 show that, when an olefin polymer (b1) containing intra molecular oxygen atoms is not used, the flexibility and formability of the composition deteriorate.

The results of Comparative Example 16 indicate that, when an acid modified styrene type thermoplastic elastomer (c2) is not used, the flexibility and formability of the composition are lowered.

The results of Comparative Examples 17 and 18 show that, when the amount of magnesium hydroxide, a flame retardant (d), is too small, the flame retardant quality of the composition is poor. Conversely, when this amount is too large, the flexibility and formability of the composition deteriorate.

### EXAMPLES 21 TO 30 AND COMPARATIVE EXAMPLES 19 TO 27

The components shown in Tables 9 to 12 were used in the amounts (parts by mass) indicated therein, and coated electrical cables were produced according to the methods mentioned for Examples 1 to 10. The properties of the coatings obtained were then evaluated. The results are shown in Tables 9 to 12.

TABLE 9

| | Example | Example | Example | Example | Example |
|---|---|---|---|---|---|
| | 21 | 22 | 23 | 24 | 25 |
| HDPE ¹⁾ | 65 | 50 | 65 | 30 | 50 |
| LLDPE ²⁾ | | | | | |
| EVA ³⁾ | 30 | 10 | 5 | | 30 |
| EEA ⁴⁾ | | | | 65 | |
| MAH- | 5 | 40 | 30 | 5 | 20 |
| VLDPE ¹³⁾ | | | | | |
| MAH-PP ¹¹⁾ | | | | | |
| magnesium | 110 | 100 | 120 | 250 | 30 |
| hydroxide ⁷⁾ | | | | | |
| Anti-aging | 1 | 1 | 1 | 1 | 1 |
| agent ⁸⁾ | | | | | |
| cross-linking | 2 | 4 | 4 | 4 | |
| agent ⁹⁾ | | | | | |
| total | 213 | 205 | 225 | 355 | 131 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 10

| | Example | Example | Example | Example | Example |
|---|---|---|---|---|---|
| | 26 | 27 | 28 | 29 | 30 |
| HDPE ¹⁾ | | 50 | 50 | 70 | 40 |
| LLDPE ²⁾ | 90 | | | | |
| EVA ³⁾ | 5 | 30 | | 10 | 40 |
| EEA ⁴⁾ | | | 30 | | |
| MAH- | 5 | 20 | 20 | 20 | 20 |
| VLDPE ¹³⁾ | | | | | |
| MAH-PP ¹¹⁾ | | | | | |
| magnesium | 40 | 90 | 120 | 100 | 30 |
| hydroxide ⁷⁾ | | | | | |
| Anti-aging | 1 | 1 | 1 | 1 | 1 |
| agent ⁸⁾ | | | | | |
| cross-linking | 4 | 4 | 4 | 4 | 2 |
| agent ⁹⁾ | | | | | |
| total | 145 | 195 | 225 | 205 | 133 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 11

| | Comparative | Comparative | Comparative | Comparative | Comparative |
|---|---|---|---|---|---|
| | Example 19 | Example 20 | Example 21 | Example 22 | Example 23 |
| HDPE ¹⁾ | 100 | | 10 | | |
| LLDPE ²⁾ | | | | 30 | |
| EVA ³⁾ | | 100 | | 70 | 50 |
| PP ¹⁰⁾ | | | | | |
| MAH-VLDPE ¹³⁾ | | | 90 | | 50 |
| MAH-PP ¹¹⁾ | | | | | |
| magnesium | 100 | 80 | 40 | 100 | 30 |
| hydroxide ⁷⁾ | | | | | |
| anti-aging agent ⁸⁾ | 1 | 1 | 1 | 1 | 1 |
| cross-linking agent ⁹⁾ | 4 | 2 | 4 | 2 | 2 |
| Total | 205 | 183 | 145 | 203 | 133 |
| flexibility | failed | passed | passed | passed | passed |
| wear resistance | passed | failed | failed | failed | failed |
| flame retardant | passed | passed | passed | passed | passed |
| quality | | | | | |
| formability | failed | passed | passed | passed | passed |

TABLE 12

| | Compar- | Compar- | Compar- | Compar- |
|---|---|---|---|---|
| | ative | ative | ative | ative |
| | Example 24 | Example 25 | Example 26 | Example 27 |
| HDPE ¹⁾ | 55 | 60 | 85 | 70 |
| LLDPE ²⁾ | | | | |
| EVA ³⁾ | | 10 | 10 | 25 |
| PP ¹⁰⁾ | 40 | | | |
| MAH- | 5 | | 5 | 5 |
| VLDPE ¹³⁾ | | | | |
| MAH-PP ¹¹⁾ | | 30 | | |
| magnesium | 50 | 200 | 10 | 300 |
| hydroxide ⁷⁾ | | | | |
| Anti-aging | 1 | 1 | 1 | 1 |
| agent ⁸⁾ | | | | |
| cross-linking | 4 | 4 | 2 | 2 |
| agent ⁸⁾ | | | | |
| total | 135 | 305 | 112 | 403 |
| flexibility | failed | failed | passed | failed |
| wear | passed | passed | passed | passed |
| resistance | | | | |
| flame | passed | passed | failed | passed |
| retardant | | | | |
| quality | | | | |
| formability | failed | failed | passed | failed |

Remarks: in Tables 9 to 12:
Footnotes ¹⁾ to ⁴⁾ and ⁷⁾ to¹¹⁾: see the footnotes for Tables 1 to 4.
¹³⁾ maleic anhydride modified ultra-low density polyethylene “XE070” manufactured by Mitsui Chemicals Co., Ltd.. (density: 0.893)

The results of Comparative Examples 19 to 23 show that, when the amount of any one component chosen among components (a), (b1) and (c3) is outside the range defined in the present invention, at least one of the properties tested is not satisfied.

The results of Comparative Example 24 indicate that, when an olefin polymer (b1) containing intra-molecular oxygen atoms is not used, the flexibility and formability of the composition are poor.

The results of Comparative Example 25 show that, when an acid modified styrene type thermoplastic elastomer (c3) is not used, the flexibility and formability of the composition are poor.

From the results of Comparative Examples 26 and 27, it can be understood that, when the amount of magnesium hydroxide, flame retardant as component (d), is too small, the flame retardant quality of the composition is poor. Conversely, when this amount is too large, the flexibility and formability of the composition deteriorate.

### EXAMPLES 31 TO 40 AND COMPARATIVE EXAMPLES 28 TO 36

The components shown in Tables 13 to 16 were used in the amounts (parts by mass), to produce coated electrical cables according to the methods described for Examples 1 to 10. The properties of the coatings were then evaluated. The results are shown in Tables 13 to 16.

TABLE 13

| | Example | Example | Example | Example | Example |
|---|---|---|---|---|---|
| | 31 | 32 | 33 | 34 | 35 |
| HDPE ¹⁾ | 65 | 50 | 65 | 30 | 50 |
| LLDPE ²⁾ | | | | | |
| EVA ³⁾ | 30 | 10 | 5 | | 30 |
| EEA ⁴⁾ | | | | 65 | |
| MAH- | 5 | 40 | 30 | 5 | |
| EPM ¹⁴⁾ | | | | | |
| MAH- | | | | | 20 |
| EPDM ¹⁵⁾ | | | | | |
| magnesium | 100 | 120 | 120 | 250 | 30 |
| hy- | | | | | |
| droxide ⁷⁾ | | | | | |
| Anti-aging | 1 | 1 | 2 | 1 | 1 |
| agent ⁸⁾ | | | | | |
| cross- | 4 | 4 | 2 | 4 | 4 |
| linking | | | | | |
| agent ⁹⁾ | | | | | |
| total | 205 | 225 | 224 | 355 | 135 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 14

| | Example | Example | Example | Example | Example |
|---|---|---|---|---|---|
| | 36 | 37 | 38 | 39 | 40 |
| HDPE ¹⁾ | | 50 | 50 | 70 | 40 |
| LLDPE ²⁾ | 90 | | | | |
| EVA ³⁾ | 5 | 30 | | 10 | 40 |
| EEA ⁴⁾ | | | 30 | | |
| MAH- | 5 | 20 | 20 | 20 | |
| EPM ¹⁴⁾ | | | | | |
| MAH- | | | | | 20 |
| EPDM ¹⁵⁾ | | | | | |
| magnesium | 40 | 90 | 120 | 100 | 90 |
| hy- | | | | | |
| droxide ⁷⁾ | | | | | |
| anti-aging | 1 | 1 | 1 | 1 | 1 |
| agent ⁸⁾ | | | | | |
| cross- | 4 | 4 | 4 | 4 | 2 |
| linking | | | | | |
| agent ⁹⁾ | | | | | |
| total | 145 | 195 | 225 | 205 | 193 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 15

| | Comparative | Comparative | Comparative | Comparative | Comparative |
|---|---|---|---|---|---|
| | Example 28 | Example 29 | Example 30 | Example 31 | Example 32 |
| HDPE ¹⁾ | 100 | | 10 | | |
| LLDPE ²⁾ | | | | 30 | |
| EVA ³⁾ | | 100 | | 70 | 50 |
| PP ¹⁰⁾ | | | | | |
| MAH-EPM ¹⁴⁾ | | | 90 | | 50 |
| MAH-PP ¹¹⁾ | | | | | |
| magnesium hydroxide ⁷⁾ | 100 | 80 | 60 | 100 | 30 |
| anti-aging agent ⁸⁾ | 1 | 1 | 1 | 1 | 1 |
| cross-linking agent ⁹⁾ | 4 | 2 | 4 | 2 | 2 |
| Total | 205 | 183 | 165 | 203 | 133 |
| Flexibility | failed | passed | passed | passed | passed |
| wear resistance | passed | failed | failed | failed | failed |
| flame retardant quality | passed | passed | passed | passed | passed |
| formability | failed | passed | passed | passed | passed |

TABLE 16

| | Compar- | Compar- | Compar- | Compar- |
|---|---|---|---|---|
| | ative | ative | ative | ative |
| | Example 33 | Example 34 | Example 35 | Example 36 |
| HDPE ¹⁾ | 55 | 60 | 85 | 70 |
| LLDPE ²⁾ | | | | |
| EVA ³⁾ | | 10 | 10 | 25 |
| PP ¹⁰⁾ | 40 | | | |
| MAH- | 5 | | 5 | 5 |
| VLDPE ¹³⁾ | | | | |
| MAH-PP ¹¹⁾ | | 30 | | |
| magnesium | 50 | 180 | 10 | 300 |
| hydroxide ⁷⁾ | | | | |
| Anti-aging | 1 | 1 | 1 | 1 |
| agent ⁸⁾ | | | | |
| cross-linking | 2 | 4 | 2 | 2 |
| agent ⁹⁾ | | | | |
| total | 133 | 285 | 112 | 403 |
| flexibility | failed | failed | passed | failed |
| wear | passed | passed | passed | passed |
| resistance | | | | |
| flame | passed | passed | failed | passed |
| retardant | | | | |
| quality | | | | |
| formability | failed | failed | passed | failed |

Remarks in Tables 13 to 16:
Footnotes ¹⁾ to ⁴⁾ and ⁷⁾ to¹¹⁾: refer to the footnotes for Tables 1 to 4.
¹⁴⁾ maleic anhydride modified ethylene-propylene copolymer rubber “T7741P” manufactured by JSR Co., Ltd..
¹⁵⁾ maleic anhydride (2% grafted) modified ethylene-propylene-diene copolymer rubber

The results of Comparative Examples 28 to 32 suggest that, when the amount of any one component chosen among components (a), (b1) and (c4) is outside the range defined in the present invention, at least one of the properties evaluated is not satisfied.

The results of Comparative Example 33 show that, when an olefin polymer (b1) containing intra-molecular oxygen atoms is not used, the flexibility and formability of the composition are poor.

The results of Comparative Example 34 indicate that, when an acid modified rubber (c4) is not used, the flexibility and formability of the composition are poor.

The results of Comparative Examples 35 and 36 show that, when the amount of magnesium hydroxide, which is a flame retardant (component (d)), is too small, the flame retardant quality of the composition is poor. However, when this amount is too large, the flexibility and formability of the composition are deteriorated.

### EXAMPLES 41 TO 50 AND COMPARATIVE EXAMPLES 37 TO 45

The components shown in Tables 17 to 20 were used in the amounts (parts by mass), to produce coated electrical cables according to the methods described for Examples 1 to 10. The properties of the coatings were then evaluated. The results are shown in Tables 17 to 20.

TABLE 17

| | Example | Example | Example | Example | Example |
|---|---|---|---|---|---|
| | 41 | 42 | 43 | 44 | 45 |
| HDPE ¹⁾ | 65 | 50 | 65 | 30 | 50 |
| LLDPE ²⁾ | | | | | |
| SEBS ¹⁶⁾ | 30 | 10 | | 65 | 30 |
| SEPS ¹⁷⁾ | | | 5 | | |
| MAH- | 5 | 40 | 30 | 5 | 20 |
| SEBS ¹²⁾ | | | | | |
| MAH-PP ¹¹⁾ | | | | | |
| magnesium | 90 | 100 | 90 | 250 | 30 |
| hy- | | | | | |
| droxide ⁷⁾ | | | | | |
| anti-aging | 1 | 1 | 1 | 1 | 1 |
| agent ⁸⁾ | | | | | |
| cross- | 4 | 4 | 4 | 2 | 2 |
| linking | | | | | |
| agent ⁹⁾ | | | | | |
| Total | 195 | 205 | 195 | 353 | 133 |
| flexibility | passed | passed | passed | passed | passed |
| Wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 18

| | Example | Example | Example | Example | Example |
|---|---|---|---|---|---|
| | 46 | 47 | 48 | 49 | 50 |
| HDPE ¹⁾ | | 50 | 50 | 70 | 60 |
| LLDPE ²⁾ | 90 | | | | |
| SEBS ¹⁶⁾ | 5 | 30 | | 10 | 20 |
| SEPS ¹⁷⁾ | | | 30 | | |
| MAH- | 5 | 20 | 20 | 20 | 20 |
| SEBS ¹²⁾ | | | | | |
| MAH-PP ¹¹⁾ | | | | | |
| magnesium | 40 | 120 | 90 | 100 | 30 |
| hydroxide ⁷⁾ | | | | | |
| anti-aging | 1 | 1 | 1 | 1 | 1 |
| agent ⁸⁾ | | | | | |
| cross- | 2 | 2 | 4 | 4 | 4 |
| linking | | | | | |
| agent ⁹⁾ | | | | | |
| total | 153 | 223 | 195 | 205 | 135 |
| flexibility | passed | passed | passed | passed | passed |
| wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 19

| | Comparative | Comparative | Comparative | Comparative | Comparative |
|---|---|---|---|---|---|
| | Example 37 | Example 38 | Example 39 | Example 40 | Example 41 |
| HDPE ¹⁾ | 100 | | 20 | | |
| LLDPE ²⁾ | | | | 20 | |
| SEBS ¹⁶⁾ | | 100 | | 80 | 70 |
| PP ¹⁰⁾ | | | | | |
| MAH-SEBS ¹²⁾ | | | 80 | | 30 |
| MAH-PP ¹¹⁾ | | | | | |
| magnesium hydroxide ⁷⁾ | 90 | 120 | 80 | 100 | 30 |
| anti-aging agent ⁸⁾ | 1 | 1 | 1 | 1 | 1 |
| cross-linking agent ⁹⁾ | 4 | 2 | 4 | 4 | 4 |
| Total | 195 | 223 | 185 | 205 | 135 |
| Flexibility | failed | passed | passed | passed | passed |
| wear resistance | passed | failed | failed | failed | failed |
| flame retardant quality | passed | passed | passed | passed | passed |
| formability | failed | passed | passed | passed | passed |

TABLE 20

| | Compar- | Compar- | Compar- | Compar- |
|---|---|---|---|---|
| | ative | ative | ative | ative |
| | Example 42 | Example 43 | Example 44 | Example 45 |
| HDPE ¹⁾ | 55 | 60 | 85 | 80 |
| LLDPE ²⁾ | | | | |
| SEBS ¹⁶⁾ | | 10 | 5 | 10 |
| PP ¹⁰⁾ | 40 | | | |
| MAH- | 5 | | 10 | 10 |
| SEBS ¹²⁾ | | | | |
| MAH-PP ¹¹⁾ | | 30 | | |
| magnesium | 30 | 200 | 10 | 300 |
| hydroxide ⁷⁾ | | | | |
| Anti-aging | 1 | 1 | 1 | 1 |
| agent ⁸⁾ | | | | |
| cross-linking | 2 | 4 | 4 | 4 |
| agent ⁹⁾ | | | | |
| total | 133 | 305 | 115 | 405 |
| flexibility | failed | failed | passed | failed |
| wear | passed | passed | passed | passed |
| resistance | | | | |
| flame | passed | passed | failed | passed |
| retardant | | | | |
| quality | | | | |
| formability | failed | failed | passed | failed |

Remarks in Tables 17 to 20:
Footnotes ¹⁾ to ⁴⁾ and ⁷⁾ to¹¹⁾: see the footnotes for Tables 1 to 4.
¹²⁾ see the footnotes for Tables 5 to 8.
¹⁶⁾ hydrogenated styrene-butadiene block copolymer manufactured by Asahi chemicals Co., Ltd..
¹⁷⁾ hydrogenated styrene-ethylene-propylene block copolymer manufactured by Kurare Co., Ltd..

From the results of Comparative Examples 37 to 41, it can be understood that, when the amount of any one component chosen among components (a), (b2) and (c2) is outside the range defined in the present invention, at least one of the physical properties evaluated is not sufficient.

The results of Comparative Example 42 indicate that, when an olefin polymer (b2) containing intra-molecular oxygen atoms is not used, the flexibility and formability of the composition are not sufficient.

The results of Comparative Example 43 show that, when an acid modified styrene type thermoplastic elastomer (c2) is not used, the flexibility and formability of the composition are poor.

The results of Comparative Examples 44 and 45 suggest that, when the amount of magnesium hydroxide, which is a flame retardant (component (d)), is too small, the flame retardant quality of the composition is poor. However, when this amount is too large, the flexibility and formability of the composition are poor.

### EXAMPLES 51 TO 60 AND COMPARATIVE EXAMPLES 46 TO 54

The components shown in Tables 21 to 24 were used in the amounts (parts by mass), to produce coated electrical cables according to the methods described for Examples 1 to 10. The properties of the coatings were then evaluated. The results are shown in Tables 21 to 24.

TABLE 21

| | Example | Example | Example | Example | Example |
|---|---|---|---|---|---|
| | 51 | 52 | 53 | 54 | 55 |
| HDPE ¹⁾ | 65 | 50 | 60 | 30 | 50 |
| LLDPE ²⁾ | | | | | |
| SEBS ¹⁶⁾ | 30 | 10 | | 65 | 30 |
| SEPS ¹⁷⁾ | | | 5 | | |
| MAH- | | | | | |
| EVA ⁵⁾ | | | | | |
| MAH- | 5 | 40 | 35 | 5 | 30 |
| EEA ⁶⁾ | | | | | |
| magnesium | 90 | 100 | 100 | 250 | 30 |
| hy- | | | | | |
| droxide ⁷⁾ | | | | | |
| anti-aging | 1 | 1 | 1 | 1 | 1 |
| agent ⁸⁾ | | | | | |
| cross- | 4 | 4 | 2 | 4 | 4 |
| linking | | | | | |
| agent ⁹⁾ | | | | | |
| Total | 195 | 205 | 203 | 355 | 135 |
| flexibility | passed | passed | passed | passed | passed |
| Wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 22

| | Example | Example | Example | Example | Example |
|---|---|---|---|---|---|
| | 56 | 57 | 58 | 59 | 60 |
| HDPE ¹⁾ | | 50 | 50 | 70 | 60 |
| LLDPE ²⁾ | 90 | | | | |
| SEBS ¹⁶⁾ | | 30 | 20 | | |
| SEPS ¹⁷⁾ | 5 | | | 10 | 20 |
| MAH- | 5 | 20 | | 20 | |
| EVA ⁵⁾ | | | | | |
| MAH- | | | 30 | | 20 |
| EEA ⁶⁾ | | | | | |
| magnesium | 70 | 120 | 100 | 120 | 30 |
| hy- | | | | | |
| droxide ⁷⁾ | | | | | |
| anti-aging | 1 | 1 | 1 | 1 | 1 |
| agent ⁸⁾ | | | | | |
| cross- | 4 | 4 | 4 | 4 | 4 |
| linking | | | | | |
| agent ⁹⁾ | | | | | |
| Total | 175 | 225 | 205 | 225 | 135 |
| flexibility | passed | passed | passed | passed | passed |
| Wear | passed | passed | passed | passed | passed |
| resistance | | | | | |
| flame | passed | passed | passed | passed | passed |
| retardant | | | | | |
| quality | | | | | |
| formability | passed | passed | passed | passed | passed |

TABLE 23

| | Comparative | Comparative | Comparative | Comparative | Comparative |
|---|---|---|---|---|---|
| | Example 46 | Example 47 | Example 48 | Example 49 | Example 50 |
| HDPE ¹⁾ | 100 | | 20 | | |
| LLDPE ²⁾ | | | | 20 | |
| SEBS ¹⁶⁾ | | 100 | | 80 | 50 |
| PP ¹⁰⁾ | | | | | |
| MAH-EVA ⁵⁾ | | | 80 | | 50 |
| MAH-PP ¹¹⁾ | | | | | |
| magnesium hydroxide ⁷⁾ | 90 | 120 | 50 | 100 | 40 |
| anti-aging agent ⁸⁾ | 1 | 1 | 1 | 1 | 1 |
| cross-linking agent ⁹⁾ | 4 | 2 | 2 | 4 | 4 |
| Total | 195 | 223 | 153 | 205 | 145 |
| Flexibility | failed | passed | passed | passed | passed |
| wear resistance | passed | failed | failed | failed | failed |
| flame retardant quality | passed | passed | passed | passed | passed |
| Formability | failed | passed | passed | passed | passed |

TABLE 24

| | Compar- | Compar- | Compar- | Compar- |
|---|---|---|---|---|
| | ative | ative | ative | ative |
| | Example 51 | Example 52 | Example 53 | Example 54 |
| HDPE ¹⁾ | 55 | 60 | 90 | 85 |
| LLDPE ²⁾ | | | | |
| SEBS ¹⁶⁾ | | 5 | 5 | 5 |
| PP ¹⁰⁾ | 40 | | | |
| MAH-EVA ⁵⁾ | 5 | | 5 | 10 |
| MAH-PP ¹¹⁾ | | 35 | | |
| magnesium | 200 | 180 | 10 | 300 |
| hydroxide ⁷⁾ | | | | |
| Anti-aging | 1 | 1 | 1 | 1 |
| agent ⁸⁾ | | | | |
| cross-linking | 2 | 2 | 4 | 4 |
| agent ⁹⁾ | | | | |
| total | 303 | 283 | 115 | 405 |
| flexibility | failed | failed | passed | failed |
| wear | passed | passed | passed | passed |
| resistance | | | | |
| flame | passed | passed | failed | passed |
| retardant | | | | |
| quality | | | | |
| formability | failed | failed | passed | failed |

Remarks in Tables 21 to 24:
Footnotes ¹⁾ to ⁴⁾ and ⁷⁾ to¹¹⁾: see the footnotes for Tables 1 to 4.
Footnotes ¹⁶⁾ and ¹⁷⁾: see footnotes for Tables 17 to 20.

The results of Comparative Examples 46 to 50 indicate that, when the amount of any one component chosen among components (a), (b2) and (c1) is outside the range defined in the present invention, at least one of the properties evaluated is not satisfactory.

The results of Comparative Example 51 suggest that, when an olefin polymer (b2) containing intra-molecular oxygen atoms is not used, the flexibility and formability of the composition are poor.

The results of Comparative Example 52 show that, when an acid modified styrene type thermoplastic elastomer (c1) is not used, the flexibility and formability of the composition are poor.

The results of Comparative Examples 53 and 54 indicate that, when the amount of magnesium hydroxide, flame retardant component (d), is too small, the flame retardant quality of the composition is poor, whereas, when this amount is too large, the flexibility and formability of the composition are poor.

Although the invention has been described with reference to particular means, materials and embodiments, it is to be understood that the invention is not limited to the particulars disclosed and extends to all equivalents within the scope of the claims.

The present disclosure relates to subject matter contained in priority Japanese Application No. 2001-382711, filed on Dec. 17, 2001, which is herein expressly incorporated by reference in its entirety.

What is claimed:

1. A resin composition comprising:
(a) about 30 to 90 parts by mass of polyethylene having a melt flow rate (MFR) of about 5 g/10 min at the most and a density of at least about 0.930;
(b1) about 5 to 65 parts by mass of olefin polymer containing intra molecular oxygen atoms;
(c) about 5 to 40 parts by mass of at least one acid modified polymer selected from:
(c1) acid modified olefin polymers containing intra-molecular oxygen atoms;
(c2) acid modified styrene thermoplastic elastomers;
(c3) acid-modified polyethylenes having a density of about 0.920 at the most; or
(c4) acid modified rubbers,
with the proviso that the total of components (a), (b1) and (c) represents 100 parts by mass; and
(d) about 30 to 250 parts by mass of metal hydroxide.

2. The resin composition according to claim 1, which is halogen-free.

3. The resin composition according to claim 1, wherein said resin composition is cross-linked by electron beam irradiation.

4. The resin composition according to claim 1, wherein the olefin polymer is selected from at least one of ethylene-vinyl acetate copolymers, ethylene-ethyl acrylate copolymers, or ethylene-methyl methacrylate copolymers

5. The resin composition according to claim 1, wherein the acid modified polymer is modified by at least one of maleic acid, fumaric acid, maleic anhydride, maleic acid monoester, or maleic acid diester.

6. The resin composition according to claim 1, wherein the metal hydroxide is selected from at least one of magnesium hydroxide or aluminum hydroxide.

7. A conductive element coated with the resin composition of claim 1.

8. An electrical cable coated with the resin composition of claim 1.

9. A resin composition comprising:
(a) about 30 to 90 parts by mass of polyethylene having a melt flow rate (MFR) of about 5 g/10 min at the most and a density of at least about 0.930;
(b2) about 5 to 65 parts by mass of styrene thermoplastic elastomer; and
(c) about 5 to 40 parts by mass of at least one acid modified polymer selected from:
(c1) acid modified olefin polymers containing intra-molecular oxygen atoms, or
(c2) acid modified styrene thermoplastic elastomers;
with the proviso that the total of components (a), (b2) and (c) represents 100 parts by mass; and
(d) about 30 to 250 parts by mass of metal hydroxide.

10. The resin composition according to claim 9, which is halogen-free.

11. The resin composition according to claim 9, wherein said resin composition is cross-linked by electron beam irradiation.

12. The resin composition according to claim 9, wherein the acid modified polymer is modified by at least one of maleic acid, fumaric acid, maleic anhydride, maleic acid monoester, or maleic acid diester.

13. The resin composition according to claim 9, wherein the metal hydroxide is selected from at least one of magnesium hydroxide or aluminum hydroxide.

14. A conductive element coated with the resin composition of claim 9.

15. An electrical cable coated with the resin composition of claim 9.

16. A process for preparing a coated conductor element comprising applying to a conductor element a resin composition comprising:
(a) about 30 to 90 parts by mass of polyethylene having a melt flow rate (EFR) of about 5 g/10 min at the most and a density of at least about 0.930;
(b1) about 5 to 65 parts by mass of olefin polymer containing intra molecular oxygen atoms;
(c) about 5 to 40 parts by mass of at least one acid modified polymer selected from:
(c1) acid modified olefin polymers containing intra-molecular oxygen atoms;
(c2) acid modified styrene thermoplastic elastomers;
(c3) acid-modified polyethylenes having a density of about 0.920 at the most; or
(c4) acid modified rubbers,
with the proviso that the total of components (a), (b1) and (c) represents 100 parts by mass; and
(d) about 30 to 250 parts by mass of metal hydroxide.

17. The process according to claim 16, further comprising irradiating said resin composition with electron beams.

18. The process according to claim 16, wherein the conductor element comprises an electrical cable.

19. The process according to claim 16, wherein the resin composition is extruded and shaped around the conductor element.

20. A process for preparing a coated conductor element comprising applying, to a conductor element, a resin composition comprising:
(a) about 30 to 90 parts by mass of polyethylene having a melt flow rate (MNR) of about 5 g/10 min at the most and a density of at least about 0.930;
(b2) about 5 to 65 parts by mass of styrene thermoplastic elastomer; and
(c) about 5 to 40 parts by mass of at least one acid modified polymer selected from:
(c1) acid modified olefin polymers containing intra-molecular oxygen atoms, and
(c2) acid modified styrene thermoplastic elastomers;
with the proviso that the total of components (a), (b2) and (c) represents 100 parts by mass; and
(d) about 30 to 250 parts by mass of metal hydroxide.

21. The process according to claim 20, further comprising irradiating said resin composition with electron beams.

22. The process according to claim 20, wherein the conductor element comprises an electrical cable.

23. The process according to claim 20, wherein the resin composition is extruded and shaped around the conductor element.
